(19) United States
(12) Patent Application Publication
(10) Pub. No.: US 2018/0227271 A1
(43) Pub. Date: Aug. 9, 2018

(54) METHOD FOR TRANSMITTING INFORMATION BETWEEN TWO DOMAINS WITH DISTINCT SECURITY LEVELS

(71) Applicant: AIRBUS DEFENCE AND SPACE SAS, TOULOUSE (FR)

(72) Inventors: Marc CARTIGNY, CHATOU (FR); Olivier KLOTZ, CHAMPIGNY SUR MARNE (FR); Hervé FRITSCH, PUTEAUX (FR); Claude POLETTI, FONTENAY AUX ROSES (FR)

(73) Assignee: AIRBUS DEFENCE AND SPACE SAS, TOULOUSE (FR)

(21) Appl. No.: 15/749,279

(22) PCT Filed: Aug. 2, 2016
(86) PCT No.: PCT/EP2016/068378

§ 371 Date: Jan. 31, 2018

(30) Foreign Application Priority Data
Aug. 3, 2015 (FR) 1501657

(51) Int. Cl. H04L 29/06; H04L 12/911; H04L 12/46

(52) U.S. Cl. CPC H04L 63/0227; H04L 47/825; H04L 47/34; H04L 12/4633; H04L 63/1408

(57) ABSTRACT

First and second applications are executed in a red domain, and a third application is executed in a black domain, with a lower security level, and via which a ciphered communication tunnel passes between the first and second applications. The first application transmits to the second application a nominal sequence of packets ordered according to their respective sizes; said nominal sequence is intercepted by the third application which, when it wishes to transmit information to the red domain, modifies said nominal sequence by deleting at least one packet, each deleted packet being dependent on said information; on reception of a sequence of packets supposed to be the nominal sequence of packets, the second application checks whether at least one packet has been deleted; and, if such is the case, the second application retrieves said information from the size of each packet thus deleted.

The present invention relates to transmission of information to a first application and/or a second application from a third application, the first application being executed by a first device of a first subnetwork of red type, the second application being executed on a second device in a second subnetwork of red type, the third application being executed by a device in a network of black type, each subnetwork of red type having a security level higher than the network of black type, the first and second subnetworks of red type being interconnected by a secure tunnel via the network of black type and the first and second subnetworks of red type belong to the same security domain.

Communication networks may have different requirements in terms of security of data that pass therein. Some communication networks having strong requirements in terms of security may use other communication networks in which the requirement level in terms of security is lower, in order to pass data from a communication subnetwork with strong security requirements to another one. One refers to communication network of red type for the communication network with the highest security level and to communication network of black type for the communication network with the lowest security level. For example, a first group of devices in a first communication subnetwork of red type communicates with a second group of devices in a second communication subnetwork of red type via a transit communication network that is not protected or has a security level lower than that of the red type, referred to as “of black type”. One refers also to black domain to designate the communication network of black type, and to red domain to designate the set formed by the first and second communication subnetworks of red type. So that the first group of devices and the second group of devices can communicate securely, security gateways (such as for example network encryptors) are used, defining a boundary between the black domain and the red domain. These security gateways provide confidentiality of communications, by ciphering/deciphering data that have to pass from one of the communication subnetworks of red type to the other one of the communication subnetworks of red type via the transit communication network of black type. These security gateways thus create a secure communication tunnel through the black domain, generally in accordance with the IPSec (Internet Protocol Security) standard. The communication subnetworks of red type then form a virtual private network (VPN).

Thus the data coming from/intended for communication subnetworks of red type passing over the transit communication network of black type are not transmitted in clear. In particular, the network addressing plane and the content of the communications of the red domain are inaccessible in the black domain, which allows meeting the requirements in terms of security of the red domain.

Such an architecture of communication networks with a plurality of security levels is implemented for example for networks in large companies in the energy sector in which the various production sites are connected to the head office of the company through a transit network using terrestrial communication infrastructures with a high resource capacity or radio-frequency infrastructures with a resource capacity that is limited and variable, in particular because of meteorological conditions, such as for example satellite communication infrastructures. In the context of a transit network using satellite communication infrastructures, the variability of the transmission conditions in terms of rate, latency and jitter has an impact on the communication quality and capacity. Thus, in order to ensure quality of the telecommunication services of voice and data type in a communication network of red domain, using a transit network situated in a black domain for communicating between distant subnetworks of the red domain, the transmission conditions of the transit network situated in the black domain shall be taken into account in the service admission plan used in the red domain.

One drawback of this type of communication infrastructure is that, because of the presence of the security gateways, there does not at the present time exist any suitable solution for enabling one or more devices in the transit communication network of black type to communicate with one or more devices in one or other of the communication subnetworks of red type, without having to call into question the security requirements of the communication subnetworks of red type, namely without having to create a security breach. Such information may be information on transmission conditions in the transit communication network of black type, as in the example mentioned previously, or commands, thus enabling coordinating the end-to-end quality of service (QoS) policies between the transit communication network of black type and the communication subnetworks of red type.

It is then desirable, under these circumstances, to provide a solution that enables one or more devices of the back domain to communicate information to one or more devices of the red domain, without having to call into question the security requirements of the red domain.

It is also desirable to provide a solution that is compatible with the majority of network equipment items available off the shelf, in particular with network security equipment, and which, in implementation thereof, requires neither security equipment nor additional security function at security domain boundary.

Finally, it is desirable to provide a solution that is simple to implement.

The invention relates to a method for transmitting information to a first application and/or a second application from a third application, the first application being executed in a first subnetwork of red type and the second application in a second subnetwork of red type, the third application being executed in a network of black type, each subnetwork of red type having a security level higher than the network of black type, the first and second subnetworks of red type being interconnected via the network of black type by a secure tunnel between a first security gateway of the first subnetwork of red type and a second security gateway of the second subnetwork of red type which apply ciphering and deciphering operations such that each first packet with a smaller size than a second packet results after ciphering in a first ciphered packet with a size less than or equal to the size of the packet resulting from ciphering of the second packet. The method is such that: the first application transmits to the second application a nominal sequence of packets, the packets in said normal sequence being ordered in a predefined order according to their respective sizes, and said nominal sequence being such that it is possible to determine unambiguously on reception the size of each packet that would have been removed from said sequence; network equipment of the network of black type on a mandatory path of said secure tunnel routes to the third application each packet in said nominal sequence after ciphering by the first gateway; when the third application wishes to transmit said information to the first application and/or the second application, the third application makes modifications to said nominal sequence after ciphering by the first gateway, by deleting at least one packet, each deleted packet being dependent on said information, and propagates the packets of said sequence after ciphering by the first gateway that have not been deleted; when the third application does not wish to transmit information to the first application and/or the second application, the third application propagates the packets of said nominal sequence after ciphering of the first gateway; when receiving a sequence of packets supposed to be the nominal sequence of packets, the second application checks whether at least one packet has been deleted by the third application; and when the second application detects that at least one packet has been deleted by the third application, the second application retrieves said information from the size of each thus deleted packet of said nominal sequence of packets. Thus, by relying on the size of packets of said nominal sequence, and enabling the third application to delete at least one of these packets without having access to the content thereof (because of the ciphering by the first gateway), it is possible to pass information from the third application (black domain) to the first application and/or the second application (red domain). In this implementation, neither security equipment nor additional security function is implemented at security domain boundary.

According to a particular embodiment, the nominal sequence of packets is delimited by at least one start packet and at least one end packet with predefined respective sizes that are not used in said nominal sequence of packets. Thus the nominal sequence of packets, optionally having undergone modifications by the third application, can be easily identified.

According to a particular embodiment, the packets of the nominal sequence of packets are coloured with a predefined service class, and said network equipment of the network of black type routes each packet thus coloured, coming from the first subnetwork of red type, to the third application. Thus the packets of said nominal sequence of packets are easily routed to the third application.

According to a particular embodiment, when the third application has transmitted said information to the first application and/or the second application, the first application transmits to the second application another sequence of packets representing a positive acknowledgement of receipt of said information, the packets of said other sequence being ordered in a predefined order according to their respective sizes, and said network equipment of the network of black type routes to the third application each packet of said other sequence after ciphering by the first gateway. Thus the information passed from the third application to the first application and/or the second application is acknowledged.

According to a particular embodiment, the third application maintains the modifications for each nominal sequence of packets that is received subsequently, until a predefined condition is fulfilled. Thus any losses of packets between the third application and the second application are not problematic.

According to a particular embodiment, when the second application receives a modified nominal sequence of packets, the second application waits to receive at least one other copy of said modified sequence of packets before determining what information is transmitted by the third application to the first application and/or the second application. Thus the second application is able to distinguish an absence of packet due to a deliberate action of the third application from an absence of packet due to a loss between the third application and the second application.

According to a particular embodiment, each information potentially to be transmitted from the third application to the first application and/or to the second application corresponds to a code in a predetermined look-up table, said information corresponding to a binary code MI in said look-up table, the third application repeats the following steps for each packet until all the packets of the nominal sequence of packets after ciphering are processed: recovering the size Tc of said packet; applying a function Fc to the recovered size Tc so as to obtain a binary code Mc, the function Fc being a bijective function such that, for a given packet size input among the possible sizes of the nominal sequence of packets after ciphering, the function Fc returns a binary code with a single bit at the value “1” and the other bits at the value “0”; deleting or not said packet according to the result of a logic AND operation between the binary codes MI and Mc; and the second application repeats the following steps for each packet until all the packets of the sequence supposed to be the nominal sequence of packets are processed: recovering the size T of said packet; applying a function F to the size T recovered so as to obtain a binary code M, the function F is a bijective function such that, for a given size of packet input among the possible sizes of the nominal sequence of packets, the function F returns a binary code with a single bit at the value “1” and the other bits at the value “0”, and furthermore such that, for a packet of size T resulting after ciphering by the first security gateway in a packet of size Tc, F(T)=Fc(Tc); and updating a variable MI′, initialised to the valued “0” for the very first packet of the sequence supposed to be the nominal sequence of packets, with the result of a logic OR operation between the binary code M and the variable MI′; and the variable MI′ gives a binary code representing said information in the previously mentioned look-up table. Thus encoding and decoding said information are simple operations.

According to a particular embodiment, said information represents a command to change state in a state machine. Thus it is easy to control state-machine progressions, despite the presence of domains with distinct security levels.

According to a particular embodiment, a particular packet size represents an action passing to a previous state in a predefined ordered list of the states of the state machine, and the first application transmits at least two packets of this particular size in the nominal sequence of packets, this particular size not being used in the rest of the nominal sequence, and the third application deletes a quantity x of packets of said particular size in said nominal sequence after ciphering by the first gateway in order to represent a change to a state of rank N−x. Thus larger state machines can be controlled.

According to a particular embodiment, an initialisation phase is previously implemented as follows; the first application transmits to the second application a test sequence consisting of a predefined concatenation of all the sizes of packets that can be used for generating said nominal sequence of packets, each packet of said test sequence having a different size, and said packets are ordered by increasing or decreasing size; said network equipment of the network of black type routes to the third application each packet of said test sequence after ciphering by the first gateway; the third application deletes each size doublet in the test sequence after ciphering by the first gateway and propagates the test sequence thus modified to the second application; and, when the second application receives a sequence of packets supposed to be the test sequence, the second application determines the sizes of packets that have not been deleted by the third application, these sizes of packets then being able to be used distinctly to generate said nominal sequence of packets, and informs the first application thereof. Thus it is possible to detect that the first gateway inserts padding data during ciphering operations, so that two packets of distinct sizes transmitted by the first application are found with the same size after ciphering.

According to a particular embodiment, the packets of the test sequence are coloured with a predefined service class, and said network equipment of the network of black type routes each packet thus coloured, coming from the first subnetwork of red type, to the third application. Thus the packets of said test sequence are easily routed to the third application.

According to a particular embodiment, the initialisation phase is first as follows: the first application transmits to the second application an initialisation sequence consisting of a remarkable concatenation of packets, the size of each packet in the initialisation sequence is either equal to a maximum size without fragmentation in the first and second subnetworks of red type, or equal to a minimum packet size in the first and second subnetworks of red type; and said network equipment of the network of black type routes to the third application each packet of said initialisation sequence after ciphering by the first gateway. Thus it is possible to trigger the initialisation phase without a priori knowing if and how the first gateway inserts padding data during the ciphering operations.

According to a particular embodiment, the packets of the initialisation sequence are coloured with a predefined service class, and said network equipment of the network of black type routes each packet thus coloured, coming from the first subnetwork of red type, to the third application. Thus the packets of said initialisation sequence are easily routed to the third application.

According to a particular embodiment, each information potentially to be transmitted from the third application to the first application and/or to the second application corresponds to a code in a predetermined look-up table, and: the first application transmits to the second application a sequence of packets representing a look-up table selected from a predefined set of look-up tables according to the sizes of packets that have not been deleted by the third application in the test sequence, and said sequence of packets representing the look-up table selected comprises a first set of packets representing the look-up table selected and a second set intended to enable the third application to acknowledge it by deleting at least one packet in said second set, the size of each packet of the sequence of packets representing the look-up table selected is either equal to the maximum size without fragmentation in the first and second subnetworks of red type, or equal to the minimum packet size in the first and second subnetworks of red type; and said network equipment of the network of black type routes to the third application each packet of said sequence of packets representing the look-up table selected after ciphering by the first gateway. Thus the look-up table to be applied to enable the third application to pass said information to the first application and/or to the second application is easily shared between said first, second and third applications.

The invention also relates to a system for transmitting information to a first application and/or a second application from a third application, the first application being executed in a first subnetwork of red type and the second application in a second subnetwork of red type, the third application being executed in a network of black type, each subnetwork of red type having a security level higher than the network of black type, the first and second subnetworks of red type being interconnected via the network of black type by a secure tunnel between a first security gateway of the first subnetwork of red type and a second security gateway of the second subnetwork of red type which apply ciphering and deciphering operations such that each first packet with a smaller size than a second packet results after ciphering in a first ciphered packet with a size less than or equal to the size of the packet resulting from the ciphering of the second packet. The system is such that: the first application is adapted for transmitting to the second application a nominal sequence of packets, said packets of said nominal sequence being ordered in a predefined order according to their respective sizes, and said nominal sequence being such that it is possible to determine unambiguously on reception the size of each packet that would have been removed from said sequence; a network equipment item of the network of black type on a mandatory path of said secure tunnel is adapted for routing to the third application each packet of said nominal sequence after ciphering by the first gateway; when the third application wishes to transmit said information to the first application and/or the second application, the third application is adapted for making modifications to said nominal sequence after ciphering by the first gateway, by deletion of at least one packet, each deleted packet being dependent on said information, and for propagating the packets of said sequence after ciphering by the first gateway that have not been deleted; when the third application does not wish to transmit information to the first application and/or the second application, the third application is adapted for propagating the packets of said nominal sequence after ciphering by the first gateway; on reception of a sequence of packets supposed to be the nominal sequence of packets, the second application is adapted for checking whether at least one packet has been deleted by the third application; and, when the second application detects that at least one packet has been deleted by the third application, the second application is adapted for retrieving said information from the size of each thus deleted packet of said nominal sequence of packets.

The features of the invention mentioned above, as well as others, will emerge more clearly from a reading of the following description of an example embodiment, said description being given in relation to the accompanying drawings, among which:

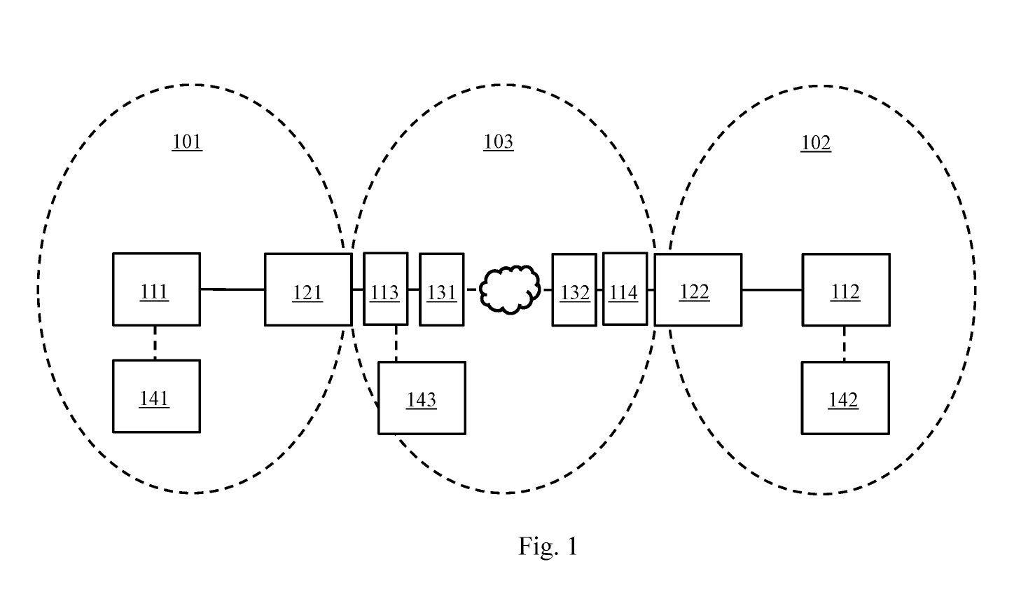

FIG. 1 illustrates schematically a communication system in which the present invention may be implemented, the communication system comprising a first communication subnetwork of red type and a second communication subnetwork of red type interconnected by a communication network of black type;

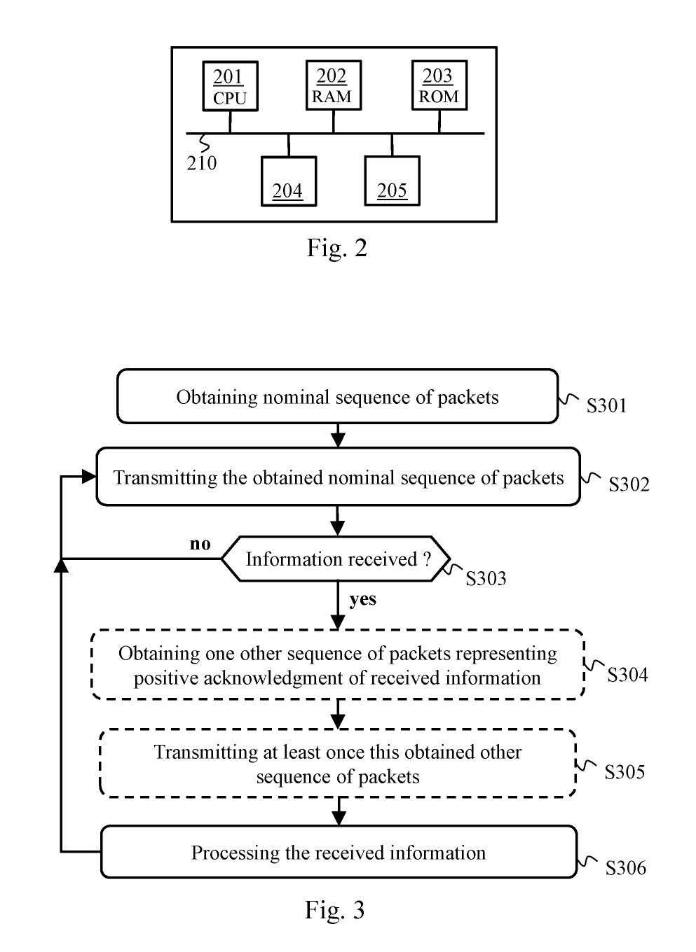

FIG. 2 illustrates schematically an example of hardware architecture of devices of the communication system;

FIG. 3 illustrates schematically an algorithm, implemented by a first application located in the first communication subnetwork of red type, to enable said first application, via a second application located in the second communication subnetwork of red type, to receive information from a third application located in the communication network of black type;

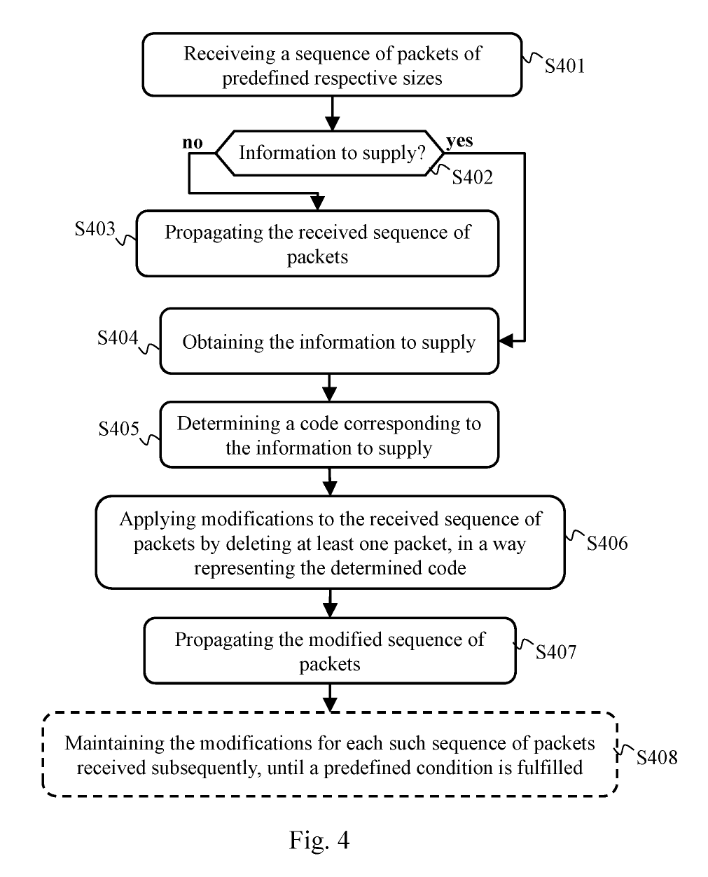

FIG. 4 illustrates schematically an algorithm, implemented by said third application, to enable said first application to receive information from said third application, via said second application;

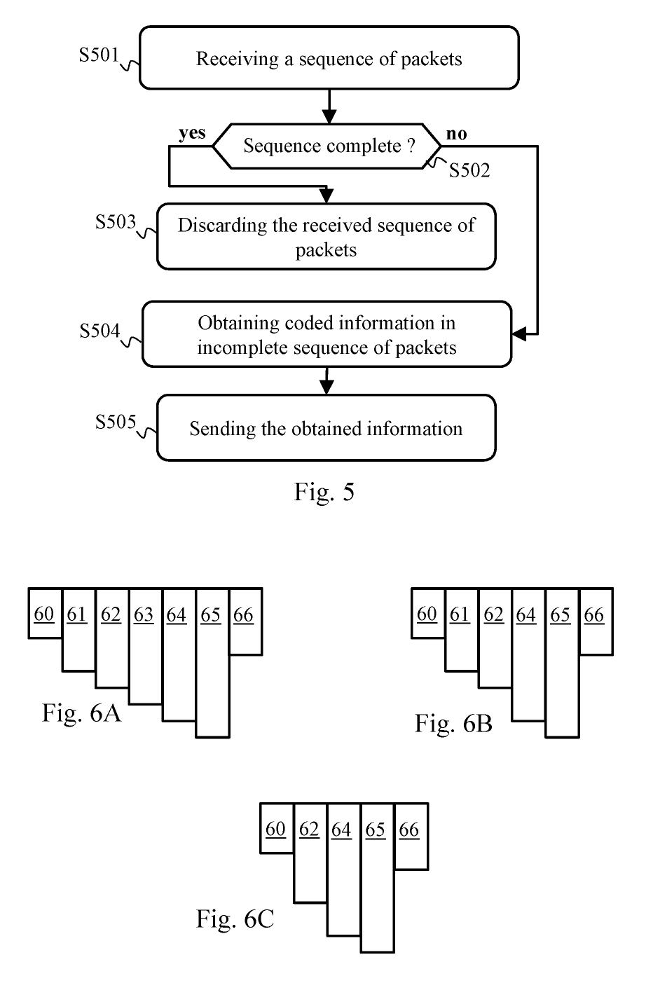

FIG. 5 illustrates schematically an algorithm, implemented by said second application to enable said first application to receive information from said third application, via said second application;

FIGS. 6A, 6B and 6C illustrate schematically sequences of packets appearing in exchanges taking place in the context of the execution of the algorithms in FIGS. 3 to 5;

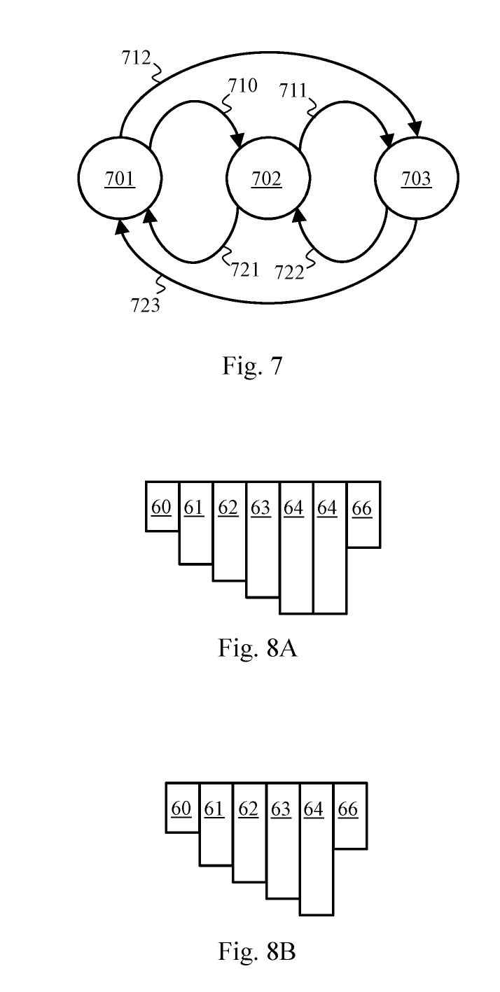

FIG. 7 illustrates schematically a state machine, which can be controlled or monitored thanks to execution of the algorithms in FIGS. 3 to 5;

FIGS. 8A and 8B illustrate schematically sequences of packets appearing in exchanges taking place in the context of the control or monitoring of the state machine in FIG. 7;

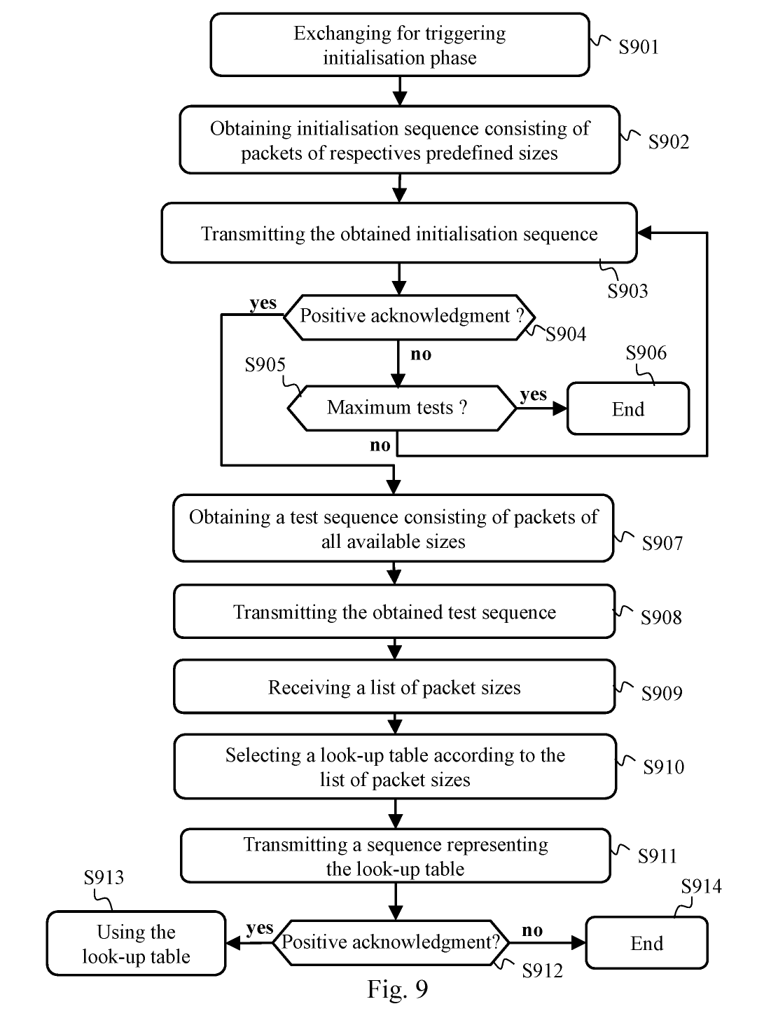

FIG. 9 illustrates schematically an algorithm implemented by said first application in the context of an initialisation phase;

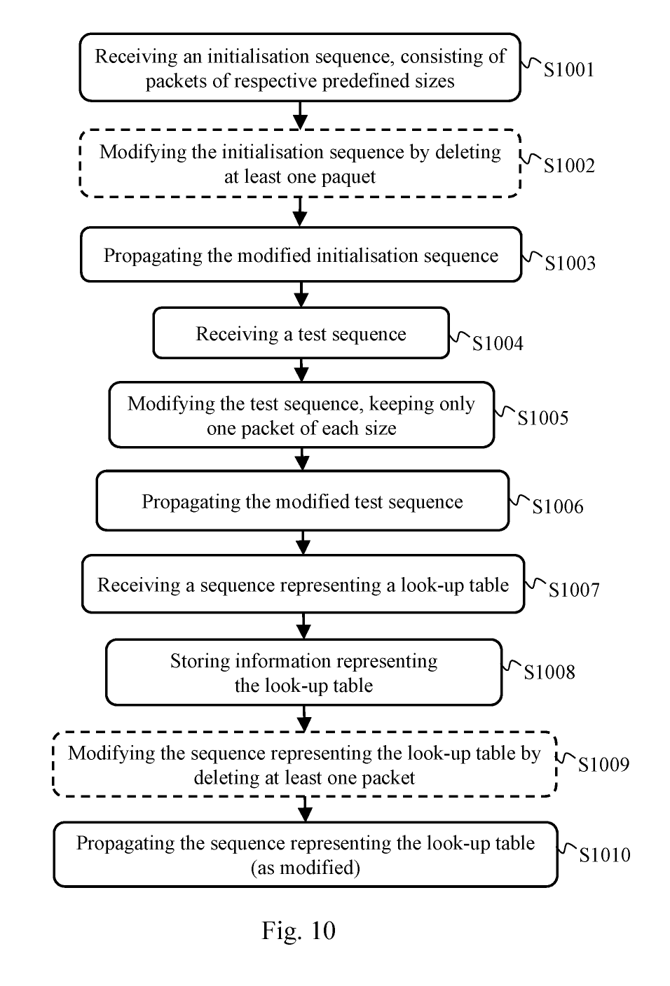

FIG. 10 illustrates schematically an algorithm implemented by said third application in the context of the initialisation phase; and

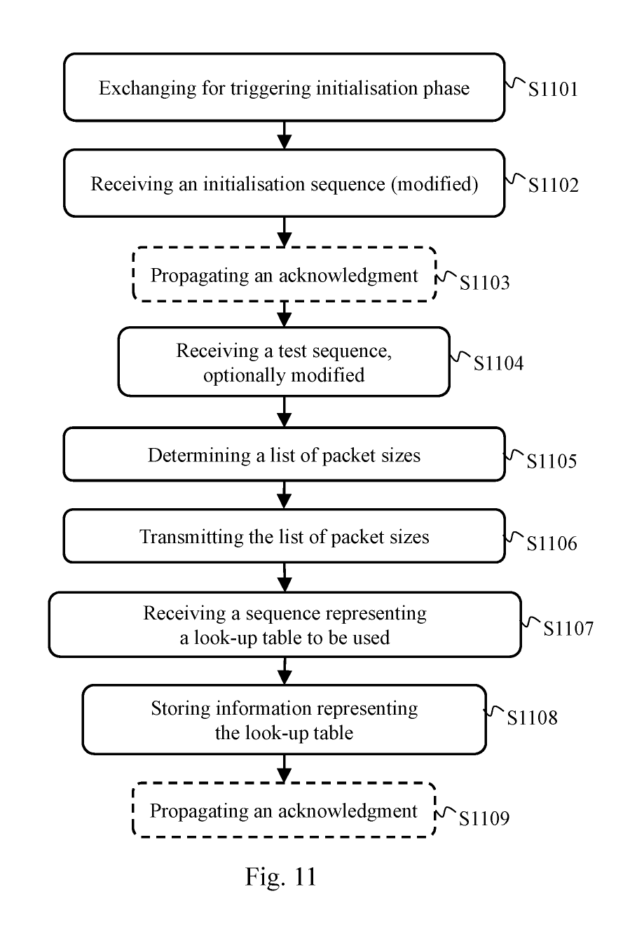

FIG. 11 illustrates schematically an algorithm implemented by said second application in the context of the initialisation phase.

FIG. 1 illustrates schematically a communication system in which the present invention may be implemented. The communication system is a packet communication system, preferably based on IP (Internet Protocol) technology.

The communication system comprises a first communication subnetwork 101 of red type and a second communication network 102 of red type interconnected by a communication network 103 of black type.

The communication network 103 of black type therefore has a lower security level than the first 101 and second 102 communication subnetworks of red type. The communication network 103 of black type comprises network equipment items 113, 114, 131, 132 enabling the first 101 and second 102 communication subnetworks of red type to be put in communication. For example, the network equipment items 113, 114 are routers routing packets within the communication network 103 of black type, and the network equipment items 131, 132 are transceiver devices communicating with each other via a satellite link. The transceiver equipment items therefore include respectively modems and antenna for using the satellite link. Other types of communication technology can be used to put the first 101 and second 102 communication subnetworks of red type in communication, whether these technologies be wired or wireless. The network equipment items 113, 114, 131, 132 preferably act at level three of the ISO (International Standardization Organization) model and more particularly at IP level.

The first communication subnetwork 101 of red type includes a first security gateway 121 and a first network equipment item 111. The first network equipment item 111 is for example a router routing packets coming from the first communication subnetwork 101 of red type and packets intended for the first communication subnetwork 101 of red type. Any router acting at level three of the ISO model, the first network equipment item 111 is preferably an IP router.

The second communication subnetwork 102 of red type includes a second security gateway 122 and a second network equipment item 112. The second network equipment item 112 is for example a router routing packets coming from the second communication subnetwork 102 of red type and packets intended for the second communication subnetwork 102 of red type. The second network equipment item 111 is preferably an IP router.

The first security gateway 121 and the second security gateway 122 are adapted for establishing a secure tunnel between the first communication subnetwork 101 of red type and the second communication subnetwork 102 of red type via the communication network 103 of black type. Thus, for each packet transmitted by a device of the first communication subnetwork 101 of red type to a device of the second communication subnetwork 102 of red type, the first security gateway 121 applies a ciphering operation before sending via the communication network 103 of black type. And, for each ciphered packet received via the communication network 103 of black type, the second security gateway 122 applies a deciphering operation before propagating said packet via the second communication subnetwork 102 of red type. Symmetrically, for each packet transmitted by a device of the second communication subnetwork 102 of red type to a device of the first communication subnetwork 101 of red type, the second security gateway 122 applies a ciphering operation before sending via the communication network 103 of black type. And, for each ciphered packet received via the communication network 103 of black type, the first security gateway 121 applies a deciphering operation before propagating said packet via the first communication subnetwork 101 of red type. A secure tunnel is thus established between the first security gateway 121 and the second security gateway 122.

Thus, according to an illustrative example shown in FIG. 1, the network equipment item 113 of the black domain is connected to the first security gateway 121 (defining the boundary between the first communication subnetwork 101 of red type and the black domain) and the network equipment item 114 of the black domain is connected to the first security gateway 122 (defining the boundary between the second communication subnetwork 102 of red type and the black domain). The network equipment 113 is also connected to the network equipment item 131 and the network equipment item 114 is also connected to the network equipment item 132 (the network equipment item 131 and the network equipment item 132 being interconnected, for example by a satellite link), thus enabling to put the communication subnetworks 101 and 102 of red type in secure communication via the communication network 103 of black type acting as a transit network.

The communication system presented in FIG. 1 is thus for example suitable for implementing secure communications of VoIP (Voice over IP) type between a telephone terminal of the first communication subnetwork 101 of red type and another type of terminal of the second communication subnetwork 102 of red type. The communication system presented in FIG. 1 is thus for example suitable for implementing secure communications of data type.

The first communication subnetwork 101 of red type further comprises a first application 141, which means a communication module acting at level seven of the ISO model, namely the layer of the ISO model closest to the “user” (in the broad sense) and which provides network services to the “user”. The first application 141 may be implemented by a device of the first communication subnetwork 101 of red type which is connected to the first network equipment item 111. In a variant, the first application 141 may be implemented by the first network equipment item 111. In a similar manner, the second communication subnetwork 102 of red type further comprises a second application 142, namely a communication module acting at level seven of the ISO model. The second application 142 may be implemented by a device of the second communication subnetwork 102 of red type which is connected to the second network equipment item 112. In a variant, the second application 142 may be implemented by the second network equipment item 112. In addition, the communication network 103 of black type further comprises a third application 143, namely a communication module acting at level seven of the ISO model. The third application 143 may be implemented by a device of the communication network 103 of black type which is connected to the network equipment items 131, 132 (in the communication network 103 of black type, every device is directly or indirectly connected to the network equipment items 131, 132). In a variant, the third application 143 may be implemented by one or other of the network equipment items 131, 132.

The first 141, second 142 and third 143 applications interact so as to enable the third application to transmit information to the first application 141 and/or to the second application 142 (namely to the red domain), despite the presence of the first 121 and second 122 security gateways. In this context, the behaviour of the first application 141 is described below in relation to FIG. 3, the behaviour of the second application 142 is described below in relation to FIG. 5 and the behaviour of the third application 143 is described below in relation to FIG. 4. In a particular embodiment, the first 141, second 142 and third 143 applications implement an initialisation phase. In this context, the behaviour of the first application 141 is described below in relation to FIG. 9, the behaviour of the second application 142 is described below in relation to FIG. 11 and the behaviour of the third application 143 is described below in relation to FIG. 10.

FIG. 2 illustrates schematically an example of hardware architecture of devices of the communication system. More particularly, FIG. 2 illustrates schematically an example of hardware architecture suited to implement the first 141, second 142 and third 143 applications. Let us consider by way of illustration that the example of hardware architecture shown schematically in FIG. 2 corresponds to a machine on which the first application 141 is executed.

The machine on which the first application 141 is executed then includes, connected by a communication bus 210, a processor or CPU (Central Processing Unit) 201; a random access memory (RAM) 202; a read only memory (ROM) 203; a storage unit 204 or a storage medium reader, such as a SD (Secure Digital) card reader or a hard disk drive (HDD); and at least one interface 205 enabling the machine on which the first application 141 is executed to communicate in the communication system.

The processor 201 is capable of executing instructions loaded into the RAM 202 from the ROM 203, or from an external memory or from a storage medium, or from a communication network. When the machine on which the first application 141 is executed is powered up, the processor 201 is capable of reading instructions from the RAM 202 and executing them. These instructions form a computer program causing the implementation, by the processor 201, all or some of the algorithms and steps described below in relation to the first application 141. The same applies to the machine on which the second application 142 is executed and the machine on which the third application 143 is executed.

All or some of the algorithms and steps described below can thus be implemented in software form by execution of a set of instructions by a programmable machine, such as a DSP (Digital Signal Processor) or a microcontroller, or be implemented in hardware form by a machine or a dedicated component such as an FPGA (Field-Programmable Gate Array) or an ASIC (Application-Specific Integrated Circuit).

FIG. 3 illustrates schematically an algorithm, implemented by the first application 141, to enable said first application 141 to receive information from the third application 143, via the second application 142.

In a step S301, the first application 141 obtains a sequence of packets of predefined respective sizes. This sequence of packets is hereinafter referred to as nominal sequence of packets, since it is the sequence of packets that is supposed to pass as it stands from the first communication subnetwork 101 of red type to the second communication subnetwork 102 of red type when the third application 143 has no information to provide to the red domain. In the nominal sequence of packets, the packets are ordered in a predefined order according to their respective sizes, and this order is known to the first 141, second 142 and third 143 applications. The nominal sequence of packets is such that, when one or more packets are removed from said nominal sequence of packets, it is possible to determine unambiguously on reception which packet or packets have been removed and more particularly which size each packet thus removed had. As will be apparent from a reading of the following description, what is important to enable the third application 143 to pass information to the red domain is the size of the packets propagated in the communication system rather than their respective contents (since the first 121 and second 122 security gateways perform ciphering and deciphering operations).

The content of the packets of the nominal sequence of packets has no importance in the context of the present invention. Indeed what is important is the size of these packets. The same applies to the other sequences of packets transmitted from the first application 141 to the second application 142 intended to enable the third application 143 to provide information to the red domain by deleting at least one packet in said sequence. Thus the packets of these sequences may contain dummy data, which means the sequences are created specifically for the requirement of passing information from the black domain to the red domain without the concerned packets containing any useful data. In a variant embodiment, the packets of these sequences may contain data to be transmitted from the first communication subnetwork 101 of red type to the second communication subnetwork 102 of red type (the ciphering performed by the security gateway 121 preventing any device of the black domain having access to the actual content of these packets).

According to a preferred embodiment, the nominal sequence of packets consists of a succession of packets ordered by increasing size. Alternatively, the nominal sequence of packets consists of a succession of packets ordered by decreasing size. Any other predefined ordering known to the first 141, second 142 and third 143 applications is applicable.

According to a preferred embodiment, the nominal sequence of packets is delimited by at least one start packet and at least one end packet, of predefined respective sizes. The sizes of the start and end packets are known to the first 141, second 142 and third 143 applications and are not used in said nominal sequence of packets. An example of a nominal sequence of packets comprising such start and end packets is presented below in relation to FIG. 6A. In a variant embodiment, the first application 141 transmits the nominal sequence of packets during predefined time periods (e.g. regularly) known to the second 142 and third 143 applications.

In a following step S302, the first application 141 transmits, to the second application 142, the nominal sequence of packets obtained at the step S301. Transmitting the packets of the nominal sequence of packets obtained at the step S301 is performed by relying on a transport protocol without acknowledgement or retransmission in the event of loss. In a preferred embodiment, transmitting the packets of the nominal sequence of packets is performed by relying on the UDP protocol (User Datagram Protocol), as defined by the standard RFC 768.

The nominal sequence of packets (after ciphering) is intended to be intercepted by the third application 143. A network equipment item of the black domain on a mandatory path of the secure tunnel from the first communication subnetwork 101 of red type to the second communication subnetwork 102 of red type, such as for example the network equipment item 113, is adapted for distinguishing the packets of the nominal sequence of packets (after ciphering) among the packets transported in the black domain and for routing said packets to the third application 143.

The packets of said nominal sequence are then received by the security gateway 121, which then proceeds with ciphering of said packets. This ciphering operation in general modifies the size of the packets. However, a first packet with a smaller size than the second packet results in a first ciphered packet of a size that is in general less than (and no more than equal to) the size of the packet resulting from the ciphering of the second packet. In the case where the ciphering of two packets of different sizes may lead to two respective ciphered packets of the same size, the first 141, second 142 and third 143 applications preferably establish an initialisation phase as described below in relation to FIGS. 9 to 11. The various sizes of the packets of said nominal sequence are such that the ciphering of said packets by the security gateway 121 generates respective ciphered packets of distinct sizes. After ciphering, the packets of said nominal sequence are transmitted in the black domain and are routed therein so that the third application 143 can process said packets as described below in relation to FIG. 5.

In a particular embodiment, the nominal sequence of packets is coloured with a dedicated class of service CoS, e.g. using a dedicated service class code DSCP (DiffServ CodePoint, as defined in the standard document RFC 2474). Preferably, the nominal sequence of packets is coloured with the class of service CoS with the highest priority among the classes of service CoS not used in the QoS plan implemented in the communication system (preferably, using a service class code DSCP of class CS5 or higher), in order to reduce transport latencies suffered by the nominal sequence of packets and to reduce risks of losses of packets in the nominal sequence of packets. This class of service CoS benefits, in the QoS plan, from a guaranteed routing policy by virtue of network signalling, in order to eliminate risks of losses of packets related to the QoS mechanisms in said nominal sequence of packets. The class of service CoS information is typically copied in a header in clear by the security gateway 121, 122 (in order to enable the black domain to implement a traffic management policy based on the classes of service CoS of the packets transported in the black domain). Another approach consists of using routing addresses, at the security gateways 121 and 122, that are specific to the nominal sequence of packets (specific tunnel) and which are known to the network equipment items of the black domain having to route the packets of said nominal sequence via the third application 143. The packets of said nominal sequence can therefore be easily distinguished from the other packets transported in the black domain.

In a following step S303, the first application 141 awaits information coming from the third application 143, via the second application 142. This aspect is detailed below in relation to FIGS. 4 and 5. If, within a predetermined period of time, no information coming from the third application 143 is received via the second application 142, the step S302 is reiterated with a new sending of said nominal sequence of packets. Otherwise a step S306 is performed, in which said information is processed by the first application 141. The first application 141 may then propagate said information to a network management station NMS responsible for implementing FCAPS (Fault, Configuration, Administration, Performance, Security) mechanisms for the red domain, in accordance with the ISO network management model. In a particular embodiment, said information represents transmission conditions in the black domain (e.g. indication of congestion). In another particular embodiment, said information represents a command to be applied by the first application 141 or by the network management station NMS, or even a command to change state in a state machine implemented in the red domain (e.g. by the first application 141 or by the network management station NMS of the red domain). One example of such commands may be implementation of a fall-back quality of service QoS plan, consisting of adjusting a service admission (e.g. closure/opening of certain physical interfaces and/or of certain ports, limitation of traffic of FTP (File Transfer Protocol) or HTTP (HyperText Transport Protocol) type, reduction in the number of voice calls simultaneously enabled, etc.), this fall-back quality of service QoS plan applying to all or some of the set of network equipment items at the edge with the black domain. In another particular embodiment, said information is information on change of state in a state machine implemented in the black domain (e.g. by the third application 143).

In a variant embodiment, when information coming from the third application 143 is received via the second application 142, the first application 141 performs a step S304 in which the first application 141 obtains, according to the information received at the step S303, another sequence of packets of predefined sizes, this other sequence of packets representing a positive acknowledgement of reception by the first application 141 of said information coming from the third application 143. As with the nominal sequence of packets, the packets are ordered in a predefined order according to their respective sizes, and this order is known to the first 141, second 142 and third 143 applications. As detailed below, the third application 143 generates said information by deleting at least one packet in the nominal sequence of packets (as obtained after ciphering); this modified sequence of packets represents the information that the third application 143 wishes to supply to the red domain. Thus, in a particular embodiment, the sequence of packets obtained by the first application 141 at the step S304 is the same as the nominal sequence of packets as received by the second application 142 after modification by the third application 143 in order to pass said information to the red domain.

For example, let us suppose that the nominal sequence of packets is a succession of five packets of respective sizes T1, T2, T3, T4, T5. After ciphering, the nominal sequence of packets becomes a succession of five packets of respective sizes TC1, TC2, TC3, TC4, TC5. Let us suppose also that the third application deletes the packet of size TC3 in order to provide information to the red domain. After deciphering, the modified sequence of packets becomes a succession of four packets of respective sizes T1, T2, T4, T5. The second application 142 uses a predetermined look-up table in order to determine to which information the received succession of four packets of respective sizes T1, T2, T4, T5 corresponds. The second application 142 then transmits said information to the first application 141. The first application 141 then generates the sequence of packets of the step S304 so as to consist of a succession of four packets of respective sizes T1, T2, T4, T5. The second 142 and third 143 applications are then informed of a positive acknowledgement, indicating that said information has indeed been received by said first application 141.

As with the nominal sequence of packets transmitted at the step S302, the sequence of packets obtained at the step S304 is intended to be intercepted by the third application 143. A network equipment item of the black domain on the transit path from the first communication subnetwork 101 of red type to the second communication subnetwork 102 of red type, such as for example the network equipment item 113, is adapted for distinguishing the packets of the sequence of packets obtained at the step S304 (after ciphering) among the packets transported in the black domain and for routing said packets to the third application 143.

In a particular embodiment, the sequence of packets obtained at the step S304 is coloured with a dedicated class of service CoS, e.g. using a dedicated service class code DSCP. Preferably, the sequence of packets obtained at the step S304 is coloured with the same class of service CoS as the nominal sequence of packets. Thus the sequence of packets obtained at the step S304 is preferably coloured with the class of service CoS with the highest priority among the classes of service CoS not used in the quality of service QoS plan used in the communication system (preferably, using a class of service code DSCP of level CS5 or higher), in order to reduce transport latency suffered by the sequence of packets obtained at the step S304 and to reduce risks of losses of packets in the sequence of packets obtained at the step S304). This class of service CoS benefits, in the QoS plan, from a guaranteed routing policy by virtue of network signalling, in order to eliminate risks of losses of packets related to the QoS mechanisms in said sequence of packets obtained at the step S304.

As with the nominal sequence of packets transmitted at the step S302, the sequence of packets obtained at the step S304 may be delimited by at least one start packet and by at least one end packet. In a variant embodiment, the first application 141 transmits said sequence of packets during predefined time periods known to the second 142 and third 143 applications, in which the first application 141 is supposed to transmit the nominal sequence of packets.

As with the nominal sequence of packets transmitted at the step S302, transmitting the packets of the sequence of packets obtained at the step S304 is performed by relying on a transport protocol without acknowledgement or retransmission in the case of loss. In a preferred embodiment, transmitting the packets of the sequence of packets obtained at the step S304 is performed by relying on the UDP protocol.

In a following step S305, the first application 141 transmits at least once, to the second application 142, this other sequence of packets obtained at the step S304. Preferably, said sequence of packets is transmitted at least twice, so as to counter any losses of packets that might occur en route. Preferably, said sequence of packets is coloured with the same class of service CoS as the nominal sequence of packets. Next, the first application 141 performs the step S306.

It should therefore be noted that the steps S304 and S305 are optional and advantageously enable the first application 141 to indicate to the third application 143 that the information sent by the third application 143 to the red domain has indeed been received in the red domain.

FIG. 4 illustrates schematically an algorithm implemented by the third application 143 to enable the first application 141 to receive information from said third application 143 via the second application 142.

In a step S401, the third application 143 receives a sequence of packets of predefined respective sizes. The packets of said sequence are ordered in a predefined order according to their respective sizes. The sequence of packets received at the step S401 by the third application 143 corresponds to a ciphered version of the nominal sequence of packets transmitted by the first application 141 at the step S402.

In a following step S402, the third application 143 checks whether the third application shall supply information to the first application 141 and/or to the second application 142 (i.e. to the red domain). Said information may come from a network management station NMS responsible for implementing FCAPS mechanisms for the black domain, in accordance with the ISO network management model. In general terms, said information may come from a network equipment item of the black domain.

In a particular embodiment, said information represents transmission conditions in the black domain (e.g. indication of congestion). In another particular embodiment, said information represents a command to be applied by the first application 141 or by the network management station NMS, or even a command to change state in a state machine implemented in the red domain (e.g. by the first application 141 or by the network management station NMS of the red domain). In another particular embodiment, said information is information on change of state in a state machine implemented in the black domain (e.g. by the third application 143).

If the third application 143 has to supply information to the first application 141 and/or to the second application 142, a step S404 is performed; otherwise a step S403 is performed.

In the step S403, the third application 143 propagates without modification, to the second application 142, the sequence of packets received at the step S401. The algorithm in FIG. 4 is then ended.

In the step S404, the third application 143 obtains the information to be supplied to the first application 141 and/or to the second application 142.

In a following step S405, the third application 143 determines a code corresponding to the information to be supplied. Each information potentially to be transmitted to the first application 141 and/or to the second application 142 corresponds to a code in a predetermined look-up table, known to the first 141, second 142 and third 143 applications.

In a following step S406, the third application 143 applies modifications to the sequence of packets received at the step S401, by deleting at least one packet in said sequence, in a way that represents the determined code. The third application 143 thus encodes the information to be supplied to the red domain. Taking the example dealt with in relation to FIG. 3, the sequence of packets received at the step S401 is a succession of five packets of respective sizes TC1, TC2, TC3, TC4, TC5. Let us suppose that the code to which the information to be supplied corresponds involves deleting the packet of size TC3 in order to supply said information to the first application 141 and/or to the second application 142, then the third application 143 deletes the packet of size TC3 in the sequence of packets received at the step S401. Such a modification of sequence of packets is presented below in relation to FIG. 6B. According to the code determined, more than one packet may be deleted from the sequence of packets received at the step S401. Such a modification of sequence of packets is presented below in relation to FIG. 6C.

According to a particular embodiment based on binary codes, the third application 143 obtains, thanks to the previously mentioned look-up table, a binary code MI that corresponds to the information to be transmitted to the red domain. The number of bits that can be used for defining the binary code MI, whatever the information to be transmitted, is equal to the number of packets of distinct sizes in the nominal sequence of packets after ciphering (which is therefore the same as the number of packets of distinct sizes in the nominal sequence of packets as transmitted by the first application 141). Next, each packet in the nominal sequence of packets after ciphering as received by the third application 143 is stored in a buffer of the FIFO (First-In First-Out) type. The packets are processed one after the other by the third application 143 in the following way (without necessarily waiting until all the packets in the nominal sequence of packets after ciphering are received by the third application 143):
the third application 143 destacks a packet from the FIFO buffer and recovers the size Tc thereof;
the third application 143 applies a function Fc to the size Tc recovered so as to obtain a binary code Mc. The number of bits defining the binary code Mc is equal to the number of packets of distinct sizes in the nominal sequence of packets after ciphering (which is therefore the same as the number of packets of distinct sizes in the nominal sequence of packets as transmitted by the first application 141). The function Fc is a bijective function such that, for a given packet size input among the possible sizes of the nominal sequence of packets after ciphering, the function Fc returns a binary code with a single bit at the value “1” and the other bits at the value “0”. The binary code Mc therefore represents the size of the packet destacked;
the third application 143 performs a logic AND operation between the binary codes MI and Mc. When the result of the logic AND operation is equal to the binary code Mc, then the third application 143 decides not to delete said packet and to propagate it to the second application 142; otherwise the third application 143 decides to delete said packet and not to propagate it to the second application 142. In other words, the third application 143 decides to delete or not said packet according to the result of a logic AND operation between the binary codes MI and Mc; and
the third application 143 reiterates these operations until all the packets of the nominal sequence of packets after ciphering as received by the third application 143 are destacked and processed.

In a following step S407, the third application 143 propagates, to the second application 142, the sequence of packets thus modified.

In a following optional step S408, the third application 143 maintains these modifications for each nominal sequence of packets that is received subsequently, until a predefined condition is fulfilled. In a particular embodiment, the third application 143 maintains these modifications for each nominal sequence of packets that is received subsequently until a predefined quantity Q of such nominal sequences of packets has been thus modified. This predefined quantity Q is such that, after having maintained these modifications for Q nominal sequences of successive packets, it is considered that the second application 142 has been capable of distinguishing the modifications made by the third application 143 from any losses of packets related to poor transmission conditions between the first communication subnetwork 101 of red type and the second communication subnetwork 102 of red type. According to another particular embodiment, the third application 143 maintains these modifications for each nominal sequence of packets that is received subsequently, until the first application 141 positively acknowledges reception of the information that was supplied by the third application 143 thanks to these modifications. It is thus possible to get rid of packet losses that may occur en route.

FIG. 5 illustrates schematically an algorithm implemented by the second application 142 to enable the first application 141 to receive information from the third application 143, via said second application 142.

In a step S501, the second application 142 receives a sequence of packets. The sequence of packets received is supposed to be the nominal sequence of packets transmitted by the first application 141 at the step S302 (since the second security gateway 122 has carried out a deciphering), unless the third application 143 has carried out modifications by deletion of at least one packet with respect to the sequence of packets resulting from the ciphering by the security gateway 121 of the nominal sequence of packets as transmitted by the first application 141 at the step S302. It is also possible, according to the transmission conditions in the black domain, that one or more packets may have been lost en route. All the packets of said sequence are supposed to be received when an end-of-sequence delimiter is received by the second application 142, or when a time delay of predefined duration has elapsed after reception of the last packet without a new packet that may correspond to the same sequence of packets being received.

In a following step S502, the second application 142 checks whether the sequence of packets received at the step S501 is complete, namely whether the sequence of packets received at the step S501 corresponds to the nominal sequence of packets. In a particular embodiment, if the sequence of packets received at the step S501 is incomplete, the second application 142 waits until receiving at least one other copy of said sequence of packets before determining what information is transmitted by the third application 143 to the black domain, in order to confirm that each missing packet is not due to a loss en route. If the sequence of packets received at the step S501 is complete, a step S503 is performed; otherwise a step S504 is performed.

In the step S503, the second application 142 discards the (nominal) sequence of packets received at the step S501, when it is expected that the packets of said sequence contain dummy data. The second application 142 processes the content of the packets in said sequence, when it is expected that the packets in said sequence contain useful data.

In the step S504, the second application 142 obtains information that was encoded by the third application 143 in the incomplete sequence of packets received at the step S501. As detailed in relation to FIG. 4, the third application 143 encoded said information by deleting at least one packet with respect to the sequence of packets received from the first application 141. The second application 142 detects each missing packet in the incomplete sequence of packets and deduces therefrom a corresponding code. Thanks to a predetermined look-up table, the second application 142 determines, from said code, what information is supplied by the third application 143. Taking the example dealt with in relation to FIGS. 3 and 4, the sequence of packets received at the step S501 is a succession of four packets of respective sizes T1, T2, T4, T5 (the third application having deleted the packet of size TC3). The packet of size T3 having disappeared from the sequence expected from the first application 141, the second application deduces from this what information the third application 142 has wished to pass to the red domain.

In said particular embodiment based on binary codes, each packet of the sequence of packets as received by the second application 142 is stored in a buffer of FIFO type. The packets are processed one after the other by the second application 142 in the following manner:
the second application 142 destacks a packet from the FIFO and recovers the size T thereof;
the second application 142 applies a function F to the recovered size T so as to obtain a binary code M. The number of bits defining the binary code M is equal to the number of packets of distinct sizes in the nominal sequence of packets as transmitted by the first application 141. The function F is a bijective function such that, for a given packet size input among the possible sizes of the nominal sequence of packets, the function F returns a binary code with a single bit at the value “1” and the other bits at the value “0”. The function F is also such that, for a packet of size T resulting after ciphering by the security gateway 121 in a packet of size Tc, F(T)=Fc(Tc). The binary code M therefore represents the size of the packet destacked;
the second application 142 performs a logic OR operation between the binary code M and a variable MI′, which is a binary code with the same size as the binary code M. The variable MI′ is initialised to the value “0” before destacking the very first packet from the sequence of packets as received by the second application 142. The variable MI′ is updated with the result of said logic OR operation; and
the second application 142 reiterates these operations until all the packets of the sequence of packets as received by the second application 142 are destacked and processed.

Thus, after having destacked and processed all the packets in the sequence of packets as received by the second application 142, the variable MI′ gives a binary code representing the information that the third application 143 has wished to pass to the red domain. The information that the third application 143 has wished to pass to the red domain can then be found thanks to the binary code of the variable MI′ and the previously mentioned look-up table.

In a following step S505, the second application 142 transmits, to the first application 141, the information obtained at the step S504. In a preferred embodiment, the second application 142 transmits said information using a message in a packet coloured with a class of service CoS different from that used by the first application 141 for transmitting the nominal sequence of packets at the step S302. This allows implementing in parallel a mechanism similar to the one described in relation to FIGS. 3 to 5, but in the direction of communication from the second application 142 to the first application 141, without interference between these parallel mechanisms. Preferably, sending this message is performed by relying on a transport protocol with acknowledgement and retransmission, in order to ensure good reception of said message by the first application 141. Preferably, transmitting said message is performed by relying on the TCP protocol (Transmission Control Protocol) as defined in RFC 793.

FIGS. 3 to 5 detail a mechanism in which information is transmitted by the third application 143, located in the black domain, to the first application 141, located in the red domain and generating the nominal sequence of packets that the third application 143 is liable to modify by deleting at least one packet, in order to supply said information. This mechanism is based in particular on a feedback from the second application 142 to the first application 141, which enables the first application 141 to receive said information supplied by the third application 143. This assumes that the first application 141 is the addressee of said information supplied by the third application 143. In the case where the second application 142 is the addressee of said information supplied by the third application 143, the feedback from the second application 142 to the first application 141 may be omitted, or used to request that the first application 141 should transmit a sequence of packets representing a positive acknowledgement of receipt by the second application 142 of said information supplied by the third application 143. The second application 142 in this case transmits to the first application 141 not said information supplied by the third application 143 but a request for positive acknowledgement. In addition, in this case, said information is processed by the second application 142. The second application 142 may then propagate said information to the network management station NMS responsible for implementing FCAPS mechanisms for the red domain, in accordance with the ISO network management model. As mentioned previously, said information may represent transmission conditions in the black domain (e.g. indication of congestion), or a command to be applied by the second application 142 or by the network management station NMS. Said information may also be a command to change state in a state machine implemented in the red domain (e.g. by the second application 142 or by the network management station NMS of the red domain). Said information may also be information on change of state in a state machine implemented in the black domain (e.g. by the third application 143).

FIGS. 6A, 6B and 6C illustrate schematically sequences of packets appearing in exchanges occurring in the context of execution of the algorithms in FIGS. 3 to 5. The packets are represented schematically by rectangles, the respective heights of which represent the sizes of said packets (or which differences in heights represent the relative differences in sizes of said packets).

FIG. 6A shows schematically an example of a succession of packets as sent by the first application 141 at the step S302. The succession of packets begins with a start packet 60. Said nominal sequence of packets then begins, as obtained by the first application 141 at the step S301. Said nominal sequence of packets presented comprises a set of five packets 61, 62, 63, 64, 65 ordered by increasing size. Next there comes an end packet 66. The start 60 and end 66 packets have distinct predefined respective sizes, and these sizes are not used to generate said nominal sequence of packets. When the third application 143 has no information to pass to the red domain, the second application 142 is supposed to receive the succession of packets as sent by the first application 141 at the step S302. When the third application 143 has information to pass to the red domain, the third application 143 removes at least one packet from the sequence received from the first application 141, and the second application 142 receives a sequence of packets modified with respect to the nominal sequence of packets as sent by the first application 141 at the step S302. FIG. 6B shows schematically an example of a succession of packets received by the second application 142 at the step S501, when the first application 141 has transmitted at the step S302 the nominal sequence of packets shown at FIG. 6A and the third application has removed the packet 63 (in its ciphered version) in order to pass information to the red domain. FIG. 6C shows schematically an example of a succession of packets received by the second application 142 at the step S501, when the first application 141 has transmitted at the step S302 the nominal sequence of packets shown at FIG. 6A and the third application has removed the packets 61 and 63 (in their respective ciphered versions) in order to pass information to the red domain.

By executing the algorithms in FIGS. 3 to 5, the third application 143 can pass information to the red domain. The variety of information that the third application 143 can pass to the red domain depends on the size of the used nominal sequence of packets, that is to say the quantity of possible modifications that the third application 143 is enabled to apply to the ciphered version of the nominal sequence of packets. If for example the nominal sequence of packets comprises five packets of distinct respective sizes and the third application 143 is enabled to delete only one packet of the ciphered version of the nominal sequence of packets, then the third application 143 can pass five distinct information to the red domain. If for example the nominal sequence of packets comprises five packets of distinct respective sizes and the third application 143 is allowed to delete a plurality of packets of the ciphered version of the nominal sequence of packets without however deleting all the packets, then the third application 143 can pass thirty distinct information to the red domain. The information that the third application 143 can pass to the red domain is for example predefined commands, or even commands for change of state in a state machine implemented in the red domain. This information that the third application 143 can pass to the red domain is for example information on change of state in a state machine implemented in the black domain. One example of such state machines is presented below in relation to FIG. 7.

The state machine shown in FIG. 7 comprises three states 701, 702, 703, and is, illustratively, described as being implemented in the black domain, and the third application 143 informs the first application 141 of the progress in the state machine. A transition event 710 enables to pass from the state 701 to the state 702, a transition event 711 enables to pass from the state 702 to the state 703, a transition event 712 enables to pass from the state 701 to the state 703, a transition event 721 enables to return from the state 702 to the state 701, a transition event 722 enables to return from the state 703 to the state 702, and a transition event 723 enables to return from the state 703 to the state 701. A nominal sequence of packets comprising three packets of distinct respective sizes therefore enables the third application 143 to pass information representing change-of-state events in the state machine shown in FIG. 7. In this context of a state machine, it is possible to reduce the quantity of events necessary for managing the state machine. The transition event 721 enabling to return from the state 702 to the state 701 and the transition event 722 enabling to return from the state 703 to the state 702 may be identical and signify “passing to a previous state in a predefined ordered list of the states of the state machine”. To do this, a particular predefined packet size is used. This particular size is not used in the rest of the nominal sequence. The first application 141 transmits two packets of this particular size in the nominal sequence of packets, for example at the end of said nominal sequence. When the third application 143 removes a packet corresponding to the ciphered version of one of these packets of particular size, the third application 143 requires to pass to a state of rank N−1 (considering that the current state is of rank N) in a predefined ordered list of the states of the state machine (namely to the state 701 if the current state is the state 701 and to the state 702 if the current state is the state 703). It is possible to skip to pass to a state of rank N−x, x>1, in the predefined ordered list of the states of the state machine, by using more packets of this particular size in the nominal sequence of packets. For example, the first application 141 transmits three packets of this particular size in the nominal sequence of packets, for example at the end of said nominal sequence. When the third application 143 removes a packet corresponding to the ciphered version of one of these packets of particular size, the third application 143 requires to pass to a state of rank N−1 in the predefined ordered list of states of the state machine (i.e. to the state 701 if the current state is the state 701 and to the state 702 if the current state is the state 703), and, when the third application 143 removes a packet corresponding to the ciphered version of one of these packets of particular size, the third application 143 requires to pass to a state of rank N−2 in the predefined ordered list of states of the state machine (i.e. to the state 701 if the current state is the state 703). This approach is particularly advantageous in the case where the state machine comprises a large quantity of states.

FIGS. 8A and 8B illustrate schematically sequences of packets appearing in exchanges occurring in the context of the management of the state machine presented in FIG. 7. As with FIGS. 6A to 6C, the packets are represented schematically by rectangles, the respective heights of which represent the sizes of said packets (or which differences in heights represent relative differences in sizes of said packets).

FIG. 8A shows schematically an example of a succession of packets as sent by the first application 141 at the step S302. The succession of packets begins with the start packet 60. There then begins said nominal sequence of packets, as obtained by the first application 141 at the step S301. Said nominal sequence of packets presented comprises a set of five packets. The packets 61, 62, 63 already present in FIG. 6A, and two packets 64 of identical particular size. The packets are ordered in said nominal sequence by increasing size. Next comes the end packet 66. When the third application 143 has no information to pass to the red domain, the second application 142 is supposed to receive the succession of packets as sent by the first application 141 at the step S302. When the third application 143 has information to pass to the red domain, the third application 143 removes at least one packet from the sequence received from the first application 141, and the second application 142 receives a sequence of packets modified with respect to the nominal sequence of packets as sent by the first application 141 at the step S302. FIG. 8B shows schematically an example of a succession of packets received by the second application 142 at the step S501, when the first application 141 has at the step S302 transmitted the nominal sequence of packets shown in FIG. 8A and the third application 143 has removed one of the packets 64 (in its ciphered version) in order to request the red domain to pass to a state of rank N−1 in the predefined ordered list of the states of the state machine.

The look-up tables used by the first 141, second 142 and third 143 applications may be predefined when the communication system is installed. It is however possible for the first 141, second 142 and third 143 applications not to a priori know all the specificities of the security gateways 121, 122, so that the first 141, second 142 and third 143 applications do not a priori know which size modifications the security gateway 121 makes during ciphering, according to the sizes of the packets transmitted by the first application 141. Indeed it is possible that, for certain sizes of packets transmitted by the first application 141, the security gateway 121 inserts padding data during the ciphering operation, so that two packets of distinct sizes transmitted by the first application 141 have the same size after ciphering. In order to determine the packet sizes that can be used for constructing the nominal sequence of packets, the first 141, second 142 and third 143 applications preferably set up an initialisation phase, described below in relation to FIGS. 9 to 11.

FIG. 9 illustrates schematically an algorithm implemented by the first application 141 in the context of the initialisation phase.

In a step S901, the first application 141 makes, with the second application 142, an exchange triggering the initialisation phase. To do this, the first application 141 transmits to the second application a message indicating that the first application 141 wishes to trigger the initialisation procedure. Sending this message is preferably performed by relying on a transport protocol with acknowledgement and retransmission in order to ensure good reception of said message by the second application 142. Preferably, transmitting said message is performed by relying on the TCP protocol. The first application 141 then receives a response message from the second application 142. If the response message includes information indicating that the second application 142 is ready to trigger the initialisation procedure, a step S902 is performed; otherwise the step S901 is reiterated later on.

At the moment when the initialisation phase is triggered, the first 141, second 142 and third 143 applications consider that there exist two packet sizes that can be used for constructing the nominal sequence of packets that enables passing information from the black domain to the red domain: a minimum size and a maximum size. From the point of view of the first 141 and second 142 applications, the minimum size corresponds to the size that each packet transmitted by the first application 141 to the second application 142 must have at a minimum, and the maximum size corresponds to the size that each packet transmitted by the first application 141 to the second application 142 may have at a maximum. From the point of view of the third application 143, the minimum size corresponds to the size after ciphering of a packet having a size equal to the size that each packet transmitted by the first application 141 to the second application 142 must have at a minimum, and the maximum size corresponds to the size after ciphering of a packet having a size equal to the size that each packet transmitted by the first application 141 to the second application 142 may have at a maximum. The size that each packet transmitted by the first application 141 to the second application 142 must have at a minimum and the maximum size corresponds to the size that each packet transmitted by the first application 141 to the second application 142 may have at a maximum are such that, after ciphering, the corresponding packets have distinct sizes.

In the step S902, the first application 141 obtains an initialisation sequence. The initialisation sequence consists of a remarkable concatenation of packets of predefined respective sizes. Each packet in the initialisation sequence is either of a size equal to the maximum size MTU (Maximum Transmission Unit) of the packets transmitted without fragmentation in the red domain, or of a size equal to the minimum size of the packets transmitted in the red domain. For the communication networks mentioned in the introductive part, a maximum size MTU of 1300 bytes is generally accepted by the network equipment items of the red domain, in order to remain consistent with the size of headers added by the security gateways and not to exceed in the black domain the maximum size fixed by satellite modems (maximum size MTU equal to 1500 bytes here). The arrangement of the initialisation sequence is known to the first 141, second 142 and third 143 applications.

The initialisation sequence preferably also comprises another set of packets intended to enable the third application 143 to make an acknowledgement, by deleting at least one of the packets of said other set. For example, said other set comprises at least two packets, at least one packet which size is equal to said minimum size and at least one packet which size is equal to said maximum size. The third application 143 is then supposed to delete at least one packet which size is equal to said minimum size when the third application 143 does not wish to launch the initialisation phase (negative acknowledgement), and is supposed to delete at least one packet which size is equal to said maximum size otherwise (positive acknowledgement). This aspect is detailed below in relation to FIG. 10.

In a step S903, the first application 141 transmits, to the second application 142, the initialisation sequence obtained at the step S901.

As with the nominal sequence of packets transmitted at the step S302, the initialisation sequence (after ciphering) is intended to be intercepted by the third application 143. A network equipment item of the black domain on the transit path from the first communication subnetwork 101 of red type to the second communication subnetwork 102 of red type, such as for example the network equipment item 113, is adapted for distinguishing the packets of the initialisation sequence (after ciphering) among the packets transported in the black domain and for routing said packets to the third application 143.

As with the nominal sequence of packets transmitted at the step S302, transmitting the packets of the initialisation sequence is performed by relying on a transport protocol without acknowledgement or retransmission in the case of loss. In a preferred embodiment, transmitting the packets of the initialisation sequence is performed by relying on the UDP protocol.

The packets of the initialisation sequence are then received by the security gateway 121, which then proceeds with ciphering of said packets. After ciphering, the packets of the initialisation sequence are transmitted in the black domain, in order to be processed by the third application 143 as described below in relation to FIG. 10. In a particular embodiment, the initialisation sequence is coloured with a dedicated class of service CoS, e.g. using a dedicated class of service code DSCP. Preferably, the initialisation sequence is coloured with the same class of service CoS as the nominal sequence of packets. Thus the initialisation sequence is preferably coloured with the class of service CoS with the highest priority among the classes of service CoS not used in the quality of service QoS plan used in the communication system (preferably, using a class of service code DSCP of level CS5 or higher), in order to reduce transport latencies suffered by the initialisation sequence and to reduce risks of losses of packets in the initialisation sequence. This class of service CoS benefits in the QoS plan from a routing policy guaranteed by virtue of network signalling, in order to eliminate risks of losses of packets related to the QoS mechanisms in said initialisation sequence.

In a following step S904, the first application 141 awaits a positive acknowledgement from the second application 142. As detailed below in relation to FIGS. 10 and 11, such a positive acknowledgement represents the fact that the second application 142 has detected the initialisation sequence transmitted by the first application 141 at the step S903 and that the third application 143 has indicated having recognized the ciphered version of the initialisation sequence transmitted by the first application 141 at the step S903. If in a predetermined period time no positive acknowledgement is received from the second application 142, or if a negative acknowledgement is received from the second application 142, a step S905 is performed. Otherwise a step S907 is performed.

In the step S905, the first application 141 checks whether a predefined maximum quantity of tests has been achieved in order to implement the initialisation phase. If such is the case, a step S906 is performed, during which the algorithm in FIG. 9 is ended; otherwise the step S903 is reiterated.

The implementation of an acknowledgement mechanism vis-à-vis the initialisation sequence is optional, and advantageously enables ensuring that the second 142 and third 143 applications have indeed detected the initialisation sequence transmitted by the first application 141 at the step S903.

In the step S907, the first application 141 obtains a test sequence. The test sequence consists of a predefined concatenation of all the sizes of packets that can be used (without taking into account any restrictions related to the security gateway 121) in order to generate the nominal sequence of packets that enables passing information from the black domain to the red domain. Each packet of the test sequence has a different size. In the test sequence, the packets are ordered by increasing size or by decreasing size.

In a following step S908, the first application 141 transmits, to the second application 142, the test sequence obtained at the step S907.

As with the initialisation sequence transmitted at the step S903, the test sequence (after ciphering) is intended to be intercepted by the third application 143. A network equipment item of the black domain on the transit path from the first communication subnetwork 101 of red type to the second communication subnetwork 102 of red type, such for example the network equipment item 113, is adapted for distinguishing the packets of the test sequence (after ciphering) among the packets transported in the black domain and for routing said packets to the third application 143.

The packets of the test sequence are then received by the security gateway 121, which then proceeds with ciphering of said packets. After ciphering, the packets of the test sequence are transmitted in the black domain, in order to be processed by the third application 143 as described below in relation to FIG. 10.

In a particular embodiment, the test sequence is coloured with a dedicated class of service CoS, e.g. using a dedicated class of service code DSCP. Preferably, the test sequence is coloured with the same class of service CoS as the nominal sequence of packets. Thus the test sequence is preferably coloured with the class of service CoS with the highest priority among the classes of service CoS not used in the quality of service plan QoS used in the communication system (preferably using a class of service code DSCP of level CS5 or higher), in order to reduce transport latencies suffered by the test sequence and to reduce risks of losses of packets in the test sequence. This class of service CoS benefits in the QoS plan from a routing policy guaranteed by virtue of network signalling, in order to eliminate the risks of losses of packets related to the QoS mechanisms in said test sequence.

As with the nominal sequence of packets transmitted at the step S302, transmitting the packets of the test sequence is performed by relying on a transport protocol without acknowledgement or retransmission in the case of loss. In a preferred embodiment, transmitting the packets of the test sequence is performed by relying on the UDP protocol.

In a following step S909, the first application 141 awaits a list of packets coming from the second application 142. This list contains a description of each of the packets of the test sequence that the second application 142 has actually received. Indeed, as detailed below in relation to FIG. 10, the third application 143 is liable to delete one or more packets of the test sequence in order to notify that a plurality of packets after ciphering has the same size, whereas the packets of the test sequence before ciphering have distinct respective sizes.

In a following step S910, the first application 141 selects an applicable look-up table according to the list of packets received at the step S909, and this among a predefined set of possible look-up tables. The more packets of distinct sizes there are in the list received at the step S909, the greater the variety of information that the third application 143 can pass to the red domain. Selecting a look-up table defines the nominal sequence of packets to be used, since this defines the number of packets of distinct sizes that the first application 141 can use to enable the third application 143 to pass information to the red domain.

In said particular embodiment based on binary codes, each look-up table is associated in a predefined manner with a function F and with a function Fc. Selecting the look-up table amounts to imposing the function F and also the function Fc, so that processing operations performed by the first 141, second 142 and third 143 applications are consistent with each other.

In a following step S911, the first application 141 transmits, to the second application 142, a sequence of packets representing the look-up table selected at the step S910. Said sequence therefore comprises a first set of packets that represents the look-up table selected at the step S910. Each packet of said first set has a size equal either to said maximum size or to said minimum size, and said first set is a succession of such packets so that the respective sizes of the successive packets of said first set represent the look-up table selected at the step S910.

The sequence of packets representing the look-up tale selected at the step S910 is intended to be intercepted by the third application 143. A network equipment item of the black domain on the transit path from the first communication subnetwork 101 of red type to the second communication network 102 of red type, such as for example the network equipment item 113, is adapted for distinguishing the packets of said sequence (after ciphering) among the packets transported in the black domain and for routing said packets to the third application 143.

The sequence of packets representing the look-up table selected at the step S910 preferably also comprises a second set of packets intended to enable the third application 143 to make an acknowledgement, by deleting at least one of said packets of said second set. For example, said second set comprises at least two packets, at least one packet with a size equal to said minimum size and at least one packet with a size equal to said maximum size. The third application 143 is then supposed to delete at least one packet with a size equal to said minimum size when the third application 143 is in disagreement with the look-up table selected by the first application 141 (negative acknowledgement), and is supposed to delete at least one packet with a size equal to said maximum size otherwise (positive acknowledgement), or vice-versa. This aspect is detailed below in relation to FIG. 10.

In a particular embodiment, the sequence of packets representing the look-up table selected at the step S910 is coloured with a dedicated class of service CoS, e.g. using a dedicated class of service code DSCP. Preferably, the sequence of packets representing the look-up table selected at the step S910 is coloured with the same class of service CoS as the nominal sequence of packets. Thus the sequence of packets representing the look-up table selected at the step S910 is preferably coloured with the class of service CoS with the highest priority among the service classes CoS not used in the quality of service plan QoS used in the communication system (preferably, using a class of service code DSCP of level CS5 or higher), in order to reduce transport latencies suffered by the sequence of packets representing the look-up table selected at the step S910 and reducing risks of losses of packets in the sequence of packets representing the look-up table selected at the step S910. This class of service CoS benefits in the QoS plan from a routing policy guaranteed by virtue of network signalling, in order to eliminate risks of losses of packets related to the QoS mechanisms in said sequence of packets representing the look-up table selected at the step S910.

As with the nominal sequence of packets transmitted at the step S302, transmitting the packets of the sequence of packets representing the look-up table selected at the step S910 is performed by relying on a transport protocol without acknowledgement or retransmission in the case of loss. In a preferred embodiment, transmitting the packets of the sequence of packets representing the look-up table selected at the step S910 is performed by relying on the UDP protocol.

In a following step S912, the first application 141 awaits a positive acknowledgement from the second application 142. As detailed below in relation to FIGS. 10 and 11, this positive acknowledgement represents the fact that the second application 142 has detected that the third application 143 has indicated that it has received the ciphered version of the sequence of packets representing the look-up table selected at the step S910, and therefore to be applied in the context of the execution of FIGS. 3 to 5. If a positive acknowledgement is received, a step S913 is performed, during which the first application 141 decides to apply, in the context of execution of FIGS. 3 to 5, the look-up table selected at the step S910; otherwise a step S914 is performed, during which the algorithm in FIG. 9 is ended.

FIG. 10 illustrates schematically an algorithm implemented by the third application 143 in the context of the initialisation phase.

In a step S1001, the third application 143 receives a ciphered version of the initialisation sequence transmitted by the first application 141 at the step S903.

In a following optional step S1002, the third application 143 modifies the initialisation sequence by deleting at least one packet, in order to indicate that the third application 143 has recognised the ciphered version of the initialisation sequence transmitted by the first application 141 at the step S903. In a particular embodiment already mentioned, the initialisation sequence further comprises another set of packets intended to enable the third application 143 to make an acknowledgement, by deleting at least one of the packets of said other set. For example, said other set comprises at least two packets, at least one packet with a size equal to said minimum size and at least one packet with a size equal to said maximum size. The third application 143 is then supposed to delete at least one packet of a size equal to said minimum size when the third application 143 does not wish to initiate the initialisation phase (negative acknowledgement), and is supposed to delete at least one packet of a size equal to said maximum size otherwise (positive acknowledgement).

In a following step S1003, the third application 143 propagates, to the second application 142, the initialisation sequence (in ciphered form), optionally modified at the step S1002.

In a following step S1004, the third application 143 receives another sequence of packets. This other sequence of packets is a ciphered version of the test sequence transmitted by the first application 141 at the step S908.

In a following step S1005, the third application 143 optionally modifies the sequence of packets received at the step S1004. The third application 143 parses the packets of said sequence of packets in their order of arrival, and analyses the respective sizes thereof. When the third application 143 encounters a packet size already encountered in parsing said sequence of packets, the third application 143 deletes the corresponding packet from said sequence of packets. In other words, the third application 143 eliminates the size doublets in the sequence of packets received at the step S1004. As already mentioned, these size doublets may arise following an insertion of padding data by the security gateway 121 during the operations of ciphering the packets of the test sequence sent by the first application 141 at the step S908. Since the test sequence sent by the first application 141 is based on packets ordered by increasing or decreasing size, the size doublets are successive packets in the sequence of packets received at the step S1004.

In a following step S1006, the third application 143 propagates, to the second application 142, the test sequence (in ciphered form) optionally modified at the step S1005.

In a following step S1007, the third application 143 awaits to receive a sequence of packets representing the look-up table selected by the first application 141. Said sequence of packets is the one transmitted by the first application 141 at the step S911.

In a following step S1008, the third application 143 stores information representing the look-up table selected by the first application 141, so as to apply, in the context of the execution of FIGS. 3 to 5, the look-up table selected by the first application 141. If the third application 143 is not in agreement with the look-up table selected by the first application 141, the third application 143 does not perform step S1008.

In the particular embodiment based on binary codes already mentioned, each look-up table is associated in a predefined manner with a function Fc to be applied in order to retrieve a binary code from a ciphered-packet size. The third application 143 therefore selects the function Fc to be applied in the context of the execution of FIGS. 3 to 5.

In a following optional step S1009, the third application 143 modifies the sequence of packets received at the step S1007, by deleting at least one packet, in order to indicate whether the third application 143 is in agreement with the look-up table selected by the first application 141. As indicated in relation to FIG. 9, said sequence of packets preferably comprises a set of packets intended to enable the third application 143 to make an acknowledgement, by deleting at least one of the packets of said set. For example, said set comprises at least two packets of distinct sizes, namely at least one packet with a size equal to said minimum size and at least one packet with a size equal to said maximum size. The third application 143 deletes at least one packet with a size equal to said minimum size when the third application 143 is not in agreement with the look-up table selected by the first application 141 (negative acknowledgement), and deletes at least one packet with a size equal to said maximum size otherwise (positive acknowledgement).

In a following step S1010, the third application 143 propagates, to the second application 142, the sequence modified at the step S1009.

FIG. 11 illustrates schematically an algorithm implemented by the second application 142 in the context of the initialisation phase.

In a step S1101, the second application 142 makes, with the first application 141, an exchange triggering the initialisation phase. To do this, the second application 142 receives from the first application 141 a message indicating that the first application 141 wishes to trigger the initialisation procedure. On receipt of this message, the second application 142 replies to the first application 141 with a response message. If the second application 142 is ready to trigger the initialisation procedure, the response message includes information indicating that the second application 142 is ready to trigger the initialisation procedure, and a step S1102 is performed; otherwise the step S1101 is reiterated later on. Sending this response message is preferably performed by relying on a transport protocol with acknowledgement and retransmission, in order to ensure the correct reception of said message by the first application 141. Preferably, transmitting said message is performed by relying on the TCP protocol.

In the step S1102, the second application 142 receives a sequence of packets. This sequence of packets is supposed to correspond to the initialisation sequence transmitted by the first application 141 at the step S903, optionally modified by the third application 143 at the step S1002. Let us consider hereinafter that the third application 143 is supposed to modify the initialisation sequence (in its ciphered version) in order to provide an acknowledgement.

In a following step S1103, the second application 142 checks whether the sequence of packets received at the step S1102 is complete, namely whether the sequence of packets received at the step S1101 corresponds to the initialisation sequence as transmitted by the first application 141 at the step S903. If such is the case, this means that the third application 143 has not recognised the ciphered version of the initialisation sequence transmitted by the first application 141 at the step S903, and the second application 142 then, in a step S1103, sends a negative acknowledgement to the first application 141. If the sequence of packets received at the step S1101 is incomplete and the modification corresponds to an indication that the third application 143 has recognised the ciphered version of the initialisation sequence transmitted by the first application 141 at the step S903 (modification optionally applied by the third application 143 at the step S1002), then the second application 142, at the step S1103, sends a positive acknowledgement to the first application 141, otherwise the second application 142, at the step S1103, sends a negative acknowledgement to the first application 141. Next, a step S1104 is performed. In the case where the third application is not supposed to modify the initialisation sequence (in its ciphered version) in order to provide an acknowledgement, the algorithm in FIG. 11 passes directly from the step S1102 to the step S1104.

In the following step S1104, the second application 142 receives a test sequence, optionally modified following the operations performed by the third application 143 at the step S1005. The test sequence received by the second application 142 may therefore be different from the one transmitted by the first application 141 at the step S908. The test sequence received by the second application 142 at the step S1104 contains packets that are of distinct sizes, since any doublets were eliminated by the third application 143 at the step S1005.

In a following step S1105, the second application 142 determines a list of sizes of packets present in the test sequence received at the step S1104. It is these packet sizes that can be distinctly used by the first application 141 for generating a nominal sequence of packets that enables the third application 143 to pass information to the red domain.

In a following step S1106, the second application 142 transmits, to the first application 141, the list of packet sizes determined at the step S1105.

In a following step S1107, the second application 142 receives a sequence of packets representing the look-up table selected by the first application 141. Said packet sequence is the one that was optionally modified by the third application 143 at the step S1009. Any modification made by the third application 143 at the step S1009 indicates whether the third application 143 is in agreement with the look-up table selected by the first application 141. If the third application 143 is not in agreement with the look-up table selected by the first application 141, the second application 142 propagates a negative acknowledgement to the first application 141 and ends the algorithm in FIG. 11. Otherwise, in a following step S1108, the second application 142 stores information representing the look-up table selected by the first application 141, so as to apply, in the context of execution of FIGS. 3 to 5, the look-up table selected by the first application 141. In the particular embodiment based on binary codes already mentioned, each look-up table is associated in a predefined manner with a function F to be applied in order to retrieve a binary code from a non-ciphered packet size. The second application 142 therefore selects the function F to be applied in the context of the execution of FIGS. 3 to 5. The first application 141 can do likewise. Then, in a following step S1109, the second application 142 propagates a positive acknowledgement to the first application 141 and ends the algorithm in FIG. 11.

Thus, by executing the algorithms in FIGS. 9 to 11, a look-up table suited to the functioning of the security gateway 121 is selected by the first application 141 from a predefined set of look-up tables.

1. A method for transmitting information to a first application and/or a second application from a third application, the first application being executed in a first subnetwork of red type and the second application in a second subnetwork of red type, the third application being executed in a network of black type, each subnetwork of red type having a security level higher than the network of black type, the first and second subnetworks of red type being interconnected via the network of black type by a secure tunnel between a first security gateway of the first subnetwork of red type and a second security gateway of the second subnetwork of red type which apply ciphering and deciphering operations such that each first packet with a smaller size than a second packet results after ciphering in a first ciphered packet with a size less than or equal to the size of the packet resulting from the ciphering of the second packet, wherein:
the first application transmits to the second application a nominal sequence of packets, the packets in said normal sequence being ordered in a predefined order according to their respective sizes, and said nominal sequence being such that it is possible to determine unambiguously on reception the size of each packet that would have been removed from said sequence;
network equipment of the network of black type on a mandatory path of said secure tunnel routes to the third application each packet in said nominal sequence after ciphering by the first gateway;
when the third application wishes to transmit said information to the first application and/or the second application, the third application makes modifications to said nominal sequence after ciphering by the first gateway, by deleting at least one packet, each deleted packet being dependent on said information, and propagates the packets of said sequence after ciphering by the first gateway that have not been deleted;
when the third application does not wish to transmit information to the first application and/or the second application, the third application propagates the packets of said nominal sequence after ciphering by the first gateway;
on reception of a sequence of packets supposed to be the nominal sequence of packets, the second application checks whether at least one packet has been deleted by the third application; and
when the second application detects that at least one packet has been deleted by the third application, the second application retrieves said information from the size of each thus deleted packet of said nominal sequence of packets.

2. The method according to claim 1, wherein the nominal sequence of packets is delimited by at least one start packet (60) and at least one end packet with predefined respective sizes that are not used in said nominal sequence of packets.

3. The method according to claim 1, wherein the packets of the nominal sequence of packets are coloured with a predefined service class, and wherein said network equipment of the network of black type routes each packet thus coloured, coming from the first subnetwork of red type, to the third application.

4. The method according to claim 1, wherein, when the third application has transmitted said information to the first application and/or the second application, the first application transmits to the second application another sequence of packets representing a positive acknowledgement of receipt of said information, the packets of said other sequence being ordered in a predefined order according to their respective sizes, and wherein said network equipment of the network of black type routes to the third application each packet of said other sequence after ciphering by the first gateway.

5. The method according to claim 1, wherein the third application maintains the modifications for each nominal sequence of packets that is received subsequently, until a predefined condition is fulfilled.

6. The method according to claim 5, wherein, when the second application receives a modified nominal sequence of packets, the second application waits to receive at least one other copy of said modified sequence of packets before determining what information is transmitted by the third application to the first application and/or the second application.

7. The method according to claim 1, wherein each information potentially to be transmitted from the third application to the first application and/or to the second application corresponds to a code in a predetermined look-up table, said information corresponding to a binary code MI in said look-up table,
wherein the third application repeats the following steps for each packet until all the packets of the nominal sequence of packets after ciphering are processed:
recovering the size Tc of said packet;
applying a function Fc to the recovered size Tc so as to obtain a binary code Mc, the function Fc being a bijective function such that, for a given packet size input among the possible sizes of the nominal sequence of packets after ciphering, the function Fc returns a binary code with a single bit at the value “1” and the other bits at the value “0”;
deleting or not said packet according to the result of a logic AND operation between the binary codes MI and Mc; and
wherein the second application repeats the following steps for each packet until all the packets of the sequence supposed to be the nominal sequence of packets are processed:
recovering the size T of said packet;
applying a function F to the recovered size T so as to obtain a binary code M, the function F is a bijective function such that, for a given size of packet input among the possible sizes of the nominal sequence of packets, the function F returns a binary code with a single bit at the value “1” and the other bits at the value “0”, and furthermore such that, for a packet of size T resulting after ciphering by the first security gateway in a packet of size Tc, F(T)=Fc(Tc); and
updating a variable MI′, initialised to the valued “0” for the very first packet of the sequence supposed to be the nominal sequence of packets, with the result of a logic OR operation between the binary code M and the variable MI′;
and wherein the variable MI′ gives a binary code representing said information in the previously mentioned look-up table.

8. The method according to claim 1, wherein said information represents a command to change state in a state machine.

9. The method according to claim 8, wherein a particular packet size represents an action of passing to a previous state in a predefined ordered list of the states of the state machine, and the first application transmits at least two packets of this particular size in the nominal sequence of packets, this particular size not being used in the rest of the nominal sequence, and wherein the third application deletes a quantity x of packets of said particular size in said nominal sequence after ciphering by the first gateway in order to represent a change to a state of rank N−x.

10. The method according to claim 1, wherein an initialisation phase is previously implemented as follows;
the first application transmits to the second application a test sequence consisting of a predefined concatenation of all the sizes of packets that can be used for generating said nominal sequence of packets, each packet of said test sequence having a different size, and said packets are ordered by increasing or decreasing size;
said network equipment of the network of black type routes to the third application each packet of said test sequence after ciphering by the first gateway;
the third application deletes each size doublet in the test sequence after ciphering by the first gateway and propagates the test sequence thus modified to the second application; and
when the second application receives a sequence of packets supposed to be the test sequence, the second application determines the sizes of packets that have not been deleted by the third application, these sizes of packets then being able to be used distinctly to generate said nominal sequence of packets, and informs the first application thereof.

11. The method according to claim 10, wherein the packets of the test sequence are coloured with a predefined service class, and wherein said network equipment of the network of black type routes each packet thus coloured, coming from the first subnetwork of red type, to the third application.

12. The method according to claim 10, wherein the initialisation phase is first as follows:
the first application transmits to the second application an initialisation sequence consisting of a remarkable concatenation of packets, the size of each packet in the initialisation sequence is either equal to a maximum size without fragmentation in the first and second subnetworks of red type, or equal to a minimum packet size in the first and second subnetworks of red type; and
said network equipment of the network of black type routes to the third application each packet of said initialisation sequence after ciphering by the first gateway.

13. The method according to claim 12, wherein the packets of the initialisation sequence are coloured with a predefined service class, and said network equipment of the network of black type routes each packet thus coloured, coming from the first subnetwork of red type, to the third application.

14. The method according to claim 12, wherein each information potentially to be transmitted from the third application to the first application and/or to the second application corresponds to a code in a predetermined look-up table, and:
the first application transmits to the second application a sequence of packets representing a look-up table selected from a predefined set of look-up tables according to the sizes of packets that have not been deleted by the third application in the test sequence, and said sequence of packets representing the selected look-up table comprises a first set of packets representing the selected look-up table and a second set intended to enable the third application to acknowledge it by deleting at least one packet in said second set, the size of each packet of the sequence of packets representing the selected look-up table is either equal to the maximum size without fragmentation in the first and second subnetworks of red type, or equal to the minimum packet size in the first and second subnetworks of red type; and
said network equipment of the network routes of black type to the third application each packet of said sequence of packets representing the selected look-up table after ciphering by the first gateway.

15. A system for transmitting information to a first application and/or a second application from a third application, the first application being executed in a first subnetwork of red type and the second application in a second subnetwork of red type, the third application being executed in a network of black type, each subnetwork of red type having a security level higher than the network of black type, the first and second subnetworks of red type being interconnected via the network of black type by a secure tunnel between a first security gateway of the first subnetwork of red type and a second security gateway of the second subnetwork of red type which apply ciphering and deciphering operations such that each first packet with a smaller size than a second packet results after ciphering in a first ciphered packet with a size less than or equal to the size of the packet resulting from the ciphering of the second packet, wherein:
the first application is adapted for transmitting to the second application a nominal sequence of packets, said packets of said nominal sequence being ordered in a predefined order according to their respective sizes, and said nominal sequence being such that it is possible to determine unambiguously on reception the size of each packet that would have been removed from said sequence;
a network equipment item of the network of black type on a mandatory path of said secure tunnel is adapted for routing to the third application each packet of said nominal sequence after ciphering by the first gateway;
when the third application wishes to transmit said information to the first application and/or the second application, the third application is adapted for making (S406) modifications to said nominal sequence after ciphering by the first gateway, by deleting at least one packet, each deleted packet being dependent on said information, and for propagating the packets of said sequence after ciphering by the first gateway that have not been deleted;
when the third application does not wish to transmit information to the first application and/or the second application, the third application is adapted for propagating the packets of said nominal sequence after ciphering by the first gateway;
on reception of a sequence of packets supposed to be the nominal sequence of packets, the second application is adapted for checking whether at least one packet has been deleted by the third application; and
when the second application detects that at least one packet has been deleted by the third application, the second application is adapted for retrieving said information from the size of each thus deleted packet of said nominal sequence of packets.
